(19) United States
(12) Patent Application Publication
(10) Pub. No.: US 2010/0312475 A1
(43) Pub. Date: Dec. 9, 2010

(54) TURNING DETERMINING METHOD FOR ASSISTING NAVIGATION AND TERMINAL DEVICE THEREOF

(75) Inventor: Chih-Wei Cheng, Taipei County (TW)

Correspondence Address: WPAT, PC;INTELLECTUAL PROPERTY ATTORNEYS, 2030 MAIN STREET, SUITE 1300, IRVINE, CA, 92614, US

(73) Assignees: INVENTEC APPLIANCES (SHANGHAI) CO. LTD., Shanghai City (CN); INVENTEC APPLIANCES CORP., Taipei County (TW)

(21) Appl. No.: 12/795,678

(22) Filed: Jun. 8, 2010

(30) Foreign Application Priority Data
Jun. 8, 2009 (CN) 200910146468.0

(51) Int. Cl. G01C 21/00

(52) U.S. Cl. 701/213

(57) ABSTRACT

The present invention relates to a turning determining method for assisting navigation. The navigation method provides a navigation display while a GPS terminal device is moving along a curved path and when GPS information is not available, the navigation method captures a plurality of background images upon the GPS terminal device moving along the curved path to determine a turning and maintain navigation frames. Then the background images are processed to obtain the deviation direction of the reference point by subtraction and comparison, or to capture specific object image as reference. The navigation method utilizes a GPS terminal device comprising an image capture unit to capture images.

### FIELD

The present invention relates to a global positioning system (GPS) terminal device. More specifically, the present invention relates to a GPS terminal device and a navigation method for assisting navigation by providing a turning determining method and a global positioning system terminal device thereof to maintain continuous navigation when the GPS information is not available.

### BACKGROUND

The Global Positioning System (GPS) is a space technique developed by the US military. The GPS provides reliable 3D positioning and navigation to worldwide users anywhere on or near the Earth which has an unobstructed view of four or more GPS satellites by calculation thereof. The GPS has the advantages of rendering the highly efficient worldwide and 24/7 service.

Many civilian applications benefit from the GPS technique. Besides synchronizing clocks, performing as an aid to engineering or as a surveying tool, the most common application in daily life is the vehicle navigation. First of all, a GPS navigation device is installed in the vehicle to receive the GPS positioning information. Then the precise positioning and movement information can be rendered in real time through the pre-stored map information and navigation software. Therefore, the driving experience can be improved and the inconvenience of searching on the maps can be avoided.

Notwithstanding having many advantages, GPS navigation methods still have some limits. Except the temporary malfunction of the satellites, the effect of solar wind, atmosphere concentration, building block, and hindrance, such as tunnel, bridge, or parking lot, may cause determination interruption or miscalculation.

The following three approaches are usually taken to solve the aforementioned problems: the first approach is enhancing reception ability; the second approach is temporarily substituted by the Dead Reckoning (DR) technique; and the third approach is correcting errors of the GPS by disposal of reference stations.

With the approach to enhance reception ability, the TW 1271535 patent, entitled “GPS antenna adjusting system and method thereof/GPS satellite signal strength display module and method thereof”, discloses satellite signal strength data generated for adjusting the antenna so as to improve the reception of the signal.

With the approach of the Dead Reckoning technique, the navigation system is automatically switching to the assistance navigation mode when the signal is interrupted. The moving velocity of the vehicle can be obtained by the wheel rotation transducer and the pre-stored map information to trace the user's position and to maintain navigation.

With the approach to correcting errors of the GPS by disposal of reference stations, Differential GPS (DGPS) is typically used. The DGPS corrects GPS errors by the disposal of the GPS reference stations and then broadcasts the real time value to the user within the signal transmitting area so as to correct the errors. For example, the TW 1227332 patent, entitled “device calibrating GPS/DGPS positioning deviation and eliminating hindrance effect and method thereof”, illustrates a short range communication to improve the accuracy to at least 98%.

With the approaches, comparing to the higher equipment requirement, the DR is widely developed and researched by the firms in the business because the compatibility in spite of the lower accuracy. However, the wheel rotation velocity transducer applied in the DR technique will cause errors of the velocity calculation under the following circumstances: wheel sliding, the tire radius variation caused by the tire pressure or by the erosion by the tire itself, and the transducer contamination etc.

It is therefore believed that inconvenience and deficiency exist in the GPS navigation technique, and need to be further improved. To solve the aforementioned existing problems, people skilled in the art are trying to find the perfect solution, but proper design have not been developed and there is no corresponding solution to solve the aforementioned problems, which is a long felt need. Hence, providing an innovate velocity computing method to assist navigation is an important research topic and is the goal need to be achieved.

The present invention renders an alternate solution regarding to the deficiency of the wheel transducer to determine the moving velocity.

### SUMMARY

The object of the present invention is to overcome the problem of navigation interruption in the existing navigation technique, the problem is caused by the temporary malfunction of the GPS satellite, object hindrance or interference, or the like. The object of the present invention provides a new navigation method and a GPS terminal device thereof and provides turning determining information in an assisting inertia GPS navigation system while the GPS navigation signal is interrupted. This technique is very practical.

In accordance with the object of the present invention and means solving problems, the present invention provides a GPS terminal device providing a navigation frame when the GPS terminal device is moving along a curved path and when GPS information is not available. The GPS terminal device comprises a storage unit, an image capture unit, and a processing module electrically connecting to the storage unit and the image capture unit. The storage unit stores at least one map information; the image capture unit captures a plurality of background images upon the GPS terminal device moving along the curved path; and the processing module determines a turning motion according to the map information and the background images so as to generate the turning determining information, and the processing module provides the navigation frame in accordance with the turning determining information.

The object of the present invention further can be implemented with the following technical means.

In the aforementioned GPS terminal device, the processing module comprises an image computing module to determine the turning motion according to the background images so as to generate the turning determining information.

In the aforementioned GPS terminal device, the image computing module comprises an image determining program.

In the aforementioned GPS terminal device, the image computing module comprises image processing program.

In the aforementioned GPS terminal device, the image computing module comprises a turning determining program.

In the aforementioned GPS terminal device, the image capture module comprises a charge coupled device (CCD).

In the aforementioned GPS terminal device, the GPS information is transmitted in compliance with the protocol defined by National Marine Electronic Association 0183 (NMEA 0183).

The aforementioned GPS terminal device further comprises a display unit to present the navigation frame.

In accordance with the object of the present invention and means solving problems, the present invention provides a GPS terminal device providing a navigation display when the GPS terminal device is moving along a curved path and when GPS information is not available. The navigation method comprises the following steps of: (a) storing at least one map information; (b) capturing a plurality of background images upon the GPS terminal device moving along the curved path; (c) determining a turning motion according to the map information and the background images so as to generate the turning determining information; and (d) generating the navigation display according to the turning determining information.

The object of the present invention can further be implemented with the following technical means.

In the aforementioned navigation method, the step (c) further comprises the step (c0) of compressing the background images.

In the aforementioned navigation method, the step (c) further comprises the step (c1) of converting the background images into grayscale images.

In the aforementioned navigation method, the step (c) further comprises the step (c2) of segmenting the background images into a plurality of block images.

In the aforementioned navigation method, the step (c) further comprises the step (c3) of subtracting grayscale values of the block images corresponding to two successive background images of the plurality of background images so as to define at least one corresponding point.

In the aforementioned navigation method, the step (c) further comprises the step (c4) of generating the turning determining information by identifying a deviation direction of the corresponding point.

In the aforementioned navigation method, the step (c) further comprises the step (c5) of identifying a background object from each of the two successive background images of the plurality of background images, and taking the background object in each of the two successive background images as a positioning point and a reference point respectively.

In the aforementioned navigation method, the step (c) further comprises the step (c6) of identifying a deviation direction of the positioning point and the reference point so as to generate the turning determining information.

The present invention has significant advantages and effects over the existing technical means. From the aforementioned description, the present invention provides a GPS navigation terminal device to complete the aforementioned objects. The navigation terminal device comprises a storage unit, an image capture unit, and a processing module. When the GPS navigation terminal device can not effectively receive a GPS positioning information, the road images can be captured automatically and processed by an image processing program and by a turning determining program.

Preferably, in an embodiment of the present invention, in two successive captured background images, a background object can be a positioning point and a reference point respectively. Also, a position deviation value obtained from the positioning point to the reference point can be calculated and a turning determining information can be generated to maintain navigation frames.

By the aforementioned means, the turning determining method for assisting navigation in accordance with the present invention comprises at least one of the following advantages and effects:

1. Comparing to the conventional GPS navigation system, the present invention comprises an image capture unit and a processing module, so driver's turning information can be determined by capturing the road image and the GPS interruption caused by hindrances can be effectively solved. Even suffering from the bad weather, hindrance above, or GPS navigation malfunction, the driver can still obtain position and moving direction by switching modes and by combining the turning determining result computed from the present invention with the pre-stored map information. Thus the navigation accuracy can be improved and the driving safety can be assured.

2. Lastly, comparing to DGPS technique, the cost of the present invention can be largely reduced and thus the present invention can be widely adopted.

To conclude, the present invention relates to a turning determining method for assisting navigation. In the navigation method, while a GPS terminal device is moving along a curved path and when GPS information is not available, road background is captured as a plurality of images and the images are processed to obtain the deviation direction of the reference point by subtraction and comparison. The turning thus can be determined and the navigation frame can be maintained. This navigation method utilizes a GPS terminal device comprising an image capture unit to capture images. The present invention has the cutting edge technique and significant effect, and is a novel, advanced, and utilized new design.

With these and other objects, advantages, and features of the invention that may become hereinafter apparent, the nature of the invention may be more clearly understood by reference to the detailed description of the invention, the embodiments and to the several drawings herein.

### BRIEF DESCRIPTION OF THE DRAWINGS

The exemplary embodiments of the present invention will be understood more fully from the detailed description given below and from the accompanying drawings of various embodiments of the invention, which, however, should not be taken to limit the invention to the specific embodiments, but are for explanation and understanding only.

FIG. 1 illustrates a schematic view of a GPS navigation system combining a vehicle to accomplish navigation technical means in accordance with one embodiment of the present invention;

FIG. 2 illustrates a block diagram in accordance with one embodiment of the present invention;

FIG. 3 illustrates a schematic view of a vehicle entering a hindrance area and driven on a road with straight lines in accordance with one embodiment of the present invention;

FIG. 4 illustrates a schematic view that the vehicle enters hindrance area and is on a curved lane in accordance with one embodiment of the present invention;

FIG. 5 illustrates a schematic view of the two successively captured background images that processed by the image processing program;

FIG. 5A is a schematic view that two background images are overlapped and the grayscale values thereof are subtracted;

FIG. 6 is an angle divided into six equal parts;

FIG. 6A is a schematic view that the two background images in FIG. 5 are overlapped with the angle divided into six equal parts;

FIG. 7 is a schematic view of the image effective capturing range when the image capture unit captures images;

FIG. 7A is a schematic view that the image capture unit captures the background object and generates background images at the first point of time;

FIG. 8 is a schematic view that the image capture unit captures the background object and generates background images at the second point of time;

FIG. 8A is a schematic view that two successively captured background images are overlapped;

FIG. 9 is a flow chart in accordance with the first preferred embodiment of the present invention; and

FIG. 10 is a flow chart in accordance with the second preferred embodiment of the present invention.

### DETAILED DESCRIPTION

Exemplary embodiments of the present invention are described herein in the context of a turning determining method and terminal device thereof. Reference will now be made in detail to implementations of the exemplary embodiments as illustrated in the accompanying drawings.

Those of ordinary skilled in the art will realize that the following detailed description of the exemplary embodiments is illustrative only and is not intended to be in any way limiting. Other embodiments will readily suggest themselves to such skilled persons having the benefit of this disclosure.

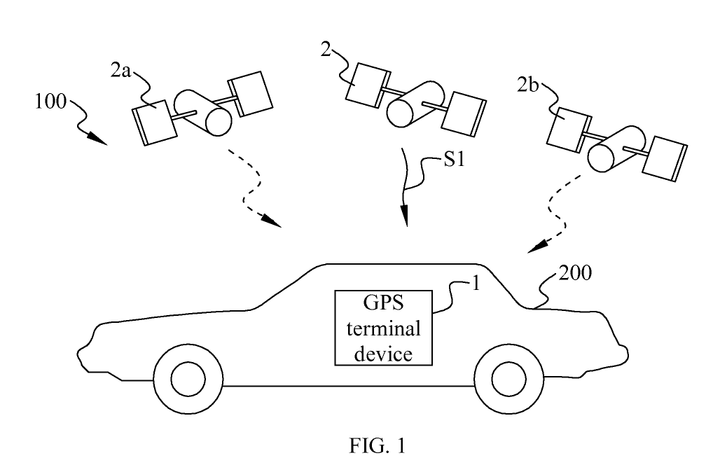

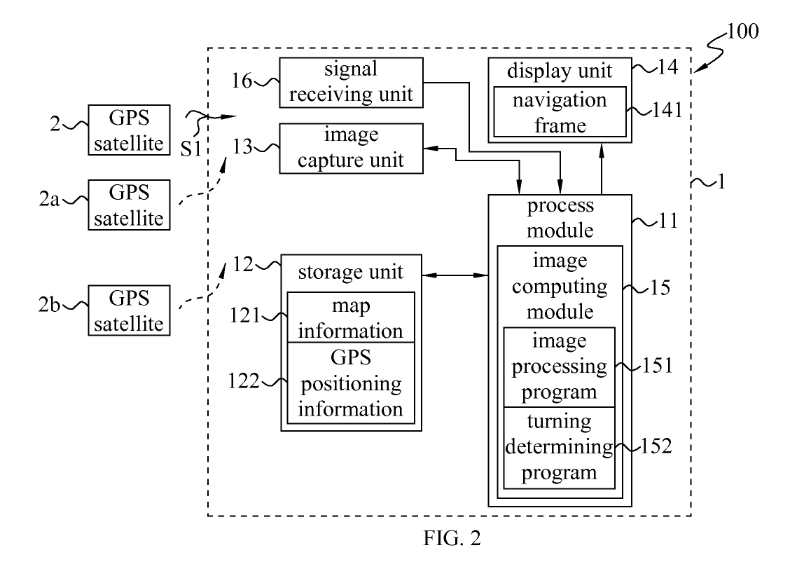

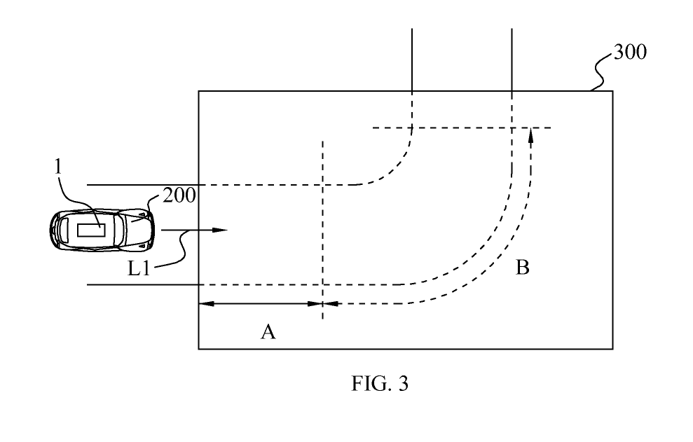

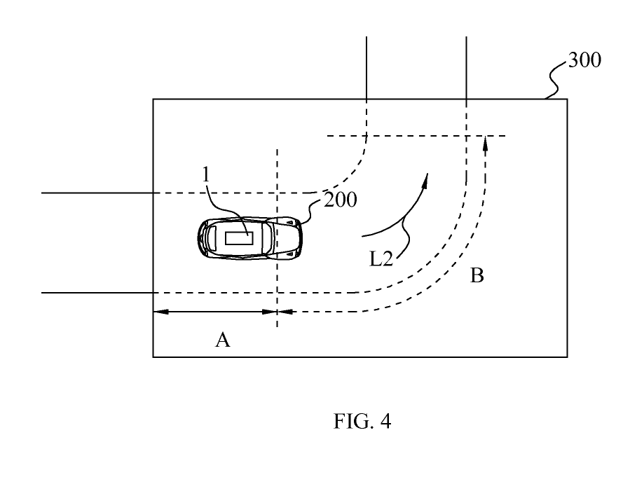

Please refer to FIG. 1 to FIG. 4, FIG. 1 is a schematic view of a GPS navigation system combining a vehicle to accomplish navigation technical means in accordance with one embodiment of the present invention; FIG. 2 is a block diagram in accordance with one embodiment of the present invention; FIG. 3 is a schematic view of a vehicle entering a hindrance area and driven on a road with straight lines in accordance with one embodiment of the present invention; FIG. 4 is a schematic view that the vehicle enters hindrance area and is on a straight lane in accordance with one embodiment of the present invention.

A Global Positioning System (GPS) navigation system 100 comprises a GPS navigation terminal device 1 and three GPS satellites (2, 2a, and 2b). The GPS navigation system terminal device 1 is installed on a vehicle 200 and the GPS satellite 2 constantly transmits positioning signal S1 to the earth.

The GPS terminal device 1 comprises a processing module 11, a storage unit 12, an image capture unit 13, a display unit 14, an image computing unit 15, and a signal receiving unit 16. The processing module 11 comprises the image computing unit 15. Besides, the storage unit 12, the image capture unit 13, the display unit 14, and the signal receiving unit 16 are electrically connected to the process module 11 respectively, and the image capture unit 13 may be a charge coupled device (CCD). Further, the storage unit 12 pre-stores at least one map information 121.

As shown in FIG. 3, the signal receiving unit 16 may receive GPS positioning signal S1 under the normal navigation status to receive the GPS position information 122 in the GPS positioning signal S1. Moreover, the GPS positioning signal S1 may usually be transmitted in compliance with the protocol defined by National Marine Electronic Association 0183 (NMEA 0183).

When a driver (not shown) drives vehicle 200 onto a road A and in the hindrance area of an obstacle 300, the signal receiving unit 16 is not able to receive the GPS positioning signal S1 and the normal navigation status will be forced to interrupt. At this time, an assisting navigation status is entered, the image capture unit 13 captures the road background as a plurality of background images 17, and then the background images are transmitted to the image computing module 15. In the image computing module 15, the background images 17 are processed by the image processing program 151 and determined by the turning determining program 152. If the driver drives on the road A, the turning determining program 152 determines that a driving route L1 is a straight route; at this time, the assisting navigation system will use acceleration sensor to calculate the coordinate of the vehicle 200, and this is general skill in the art so skipped herein.

As shown in FIG. 4, when the driver drives on the road B, the turning determining program 152 can determine the driving route L2 is a curved route based on the deviation difference generated by the successively captured background images 17; at this time, the image determining information and the map information 121 are computed together to generate a navigation frame 141 and the navigation frame 141 is displayed on the display unit 14.

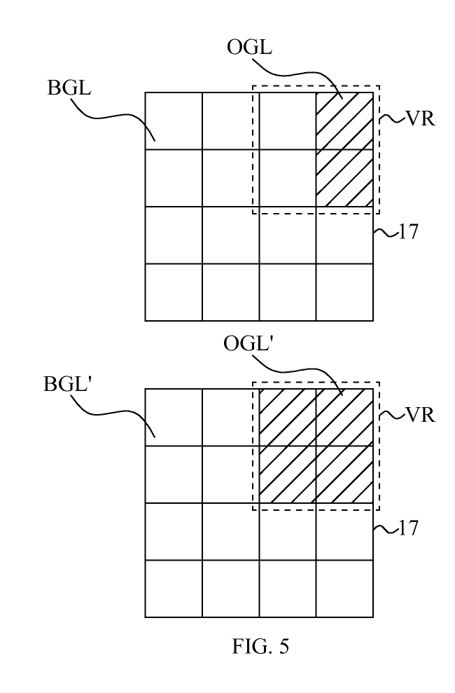

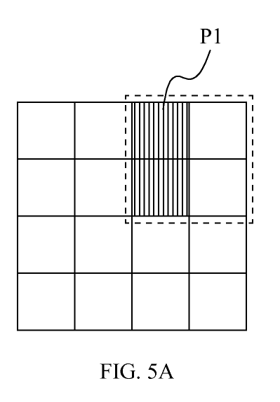

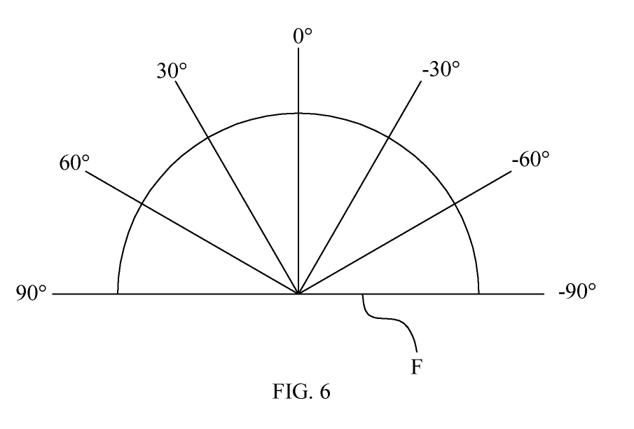

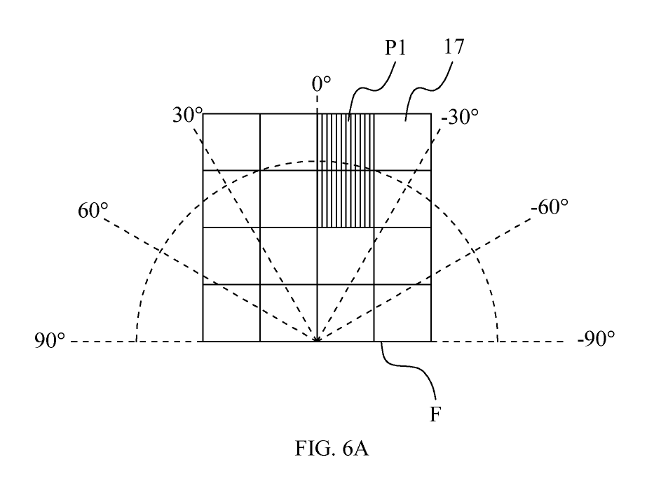

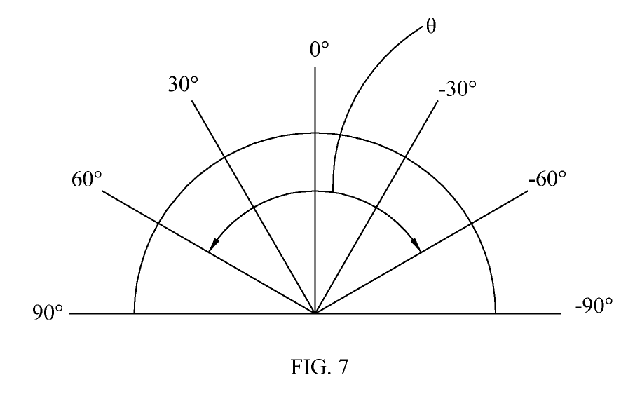

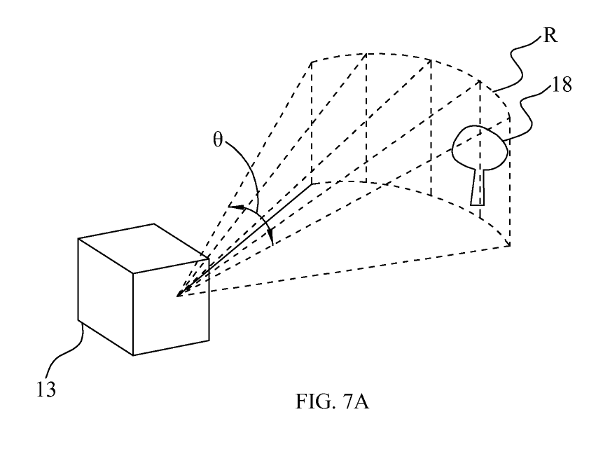

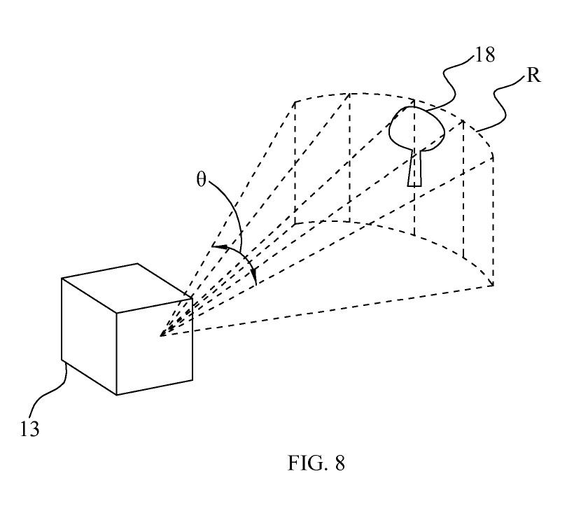

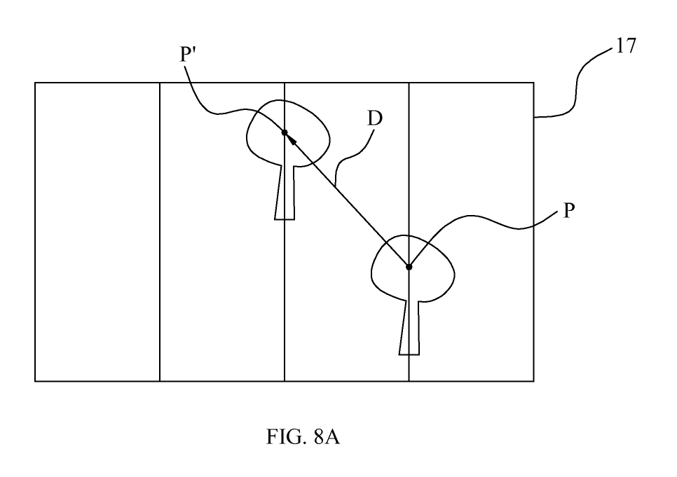

To further understand the aforementioned method, following please refer to FIG. 5 to FIG. 8A, which are schematic views that the image computing program determines the turning in accordance with the first and second preferred embodiments of the present invention, wherein FIG. 5 is a schematic view of the two successively captured background images that processed by the image processing program; FIG. 5A is a schematic view that two background images are overlapped and the grayscale values thereof are subtracted; FIG. 6 is an angle divided into six equal parts; FIG. 6A is a schematic view that the two background images in FIG. 5 are overlapped with the angle divided into six equal parts; FIG. 7 is a schematic view of the image effective capturing range when the image capture unit captures images; FIG. 7A is a schematic view that the image capture unit captures the background object and generates background images at the first point of time; FIG. 8 is a schematic view that the image capture unit captures the background object and generates background images at the second point of time; and FIG. 8A is a schematic view that two successively captured background images are overlapped.

In the first preferred embodiment of the present invention, the image capture unit 13 successively captures the road background as the background images 17. The image process program 151 compresses the two successively captured background images 17 and converts them into grayscale to generate a background grayscale level (BGL/BGL′) and an object gray scale level (OGL/OGL′) based on the difference of the grayscale value. At the mean time, as shown in FIG. 5, the image processing program 151 divides the background image 17 into a plurality of block images. Also, the compression and grayscale process are used for reducing digital number and expediting the following computing efficiency. As shown in FIG. 5A, following the two successively captured background image 17 are overlapped and the grayscale values of the block images of the two background images 17 are subtracted to obtain a grayscale variation rage VR. A corresponding point P1 can be defined according to the grayscale variation area VR. Lastly, the turning determining program 152 uses an angle divided into six equal parts onto the background images 17. The general turning can be determined by comparing the corresponding point with the dividing angle lines of the angle divided into six equal parts diagram F.

In the second preferred embodiment of the present invention, the image capture unit 13 has an image capture effective angle θ, and the image capture effective angle θ can be divided into multiple parts for further determination. When the image capture unit 13 captures the background images 17, an image capture range R is generated due to the image capture effective angle θ. Further, the image capture range R extends the deciding lines of the image capture effective angle θ and comprises the background object 18. Following the two successively captured background images are overlapped, a positioning point P can be defined according to the position of the background object 18 at the first point of time, and a reference point P′ can be defined according to the position of the background object 18 at the second point of time, wherein the displacement vector of the positioning point P and the reference point P′ can define a deviation direction D. Matching the deviation direction D to the decided line of the image capture effective angle θ can determine a general turning.

Then, to further elaborate the technical means disclosed in the present invention, the means disclosed in the first preferred embodiment and the second preferred embodiment are compiled as simple flow charts for people skilled in the art to memorize.

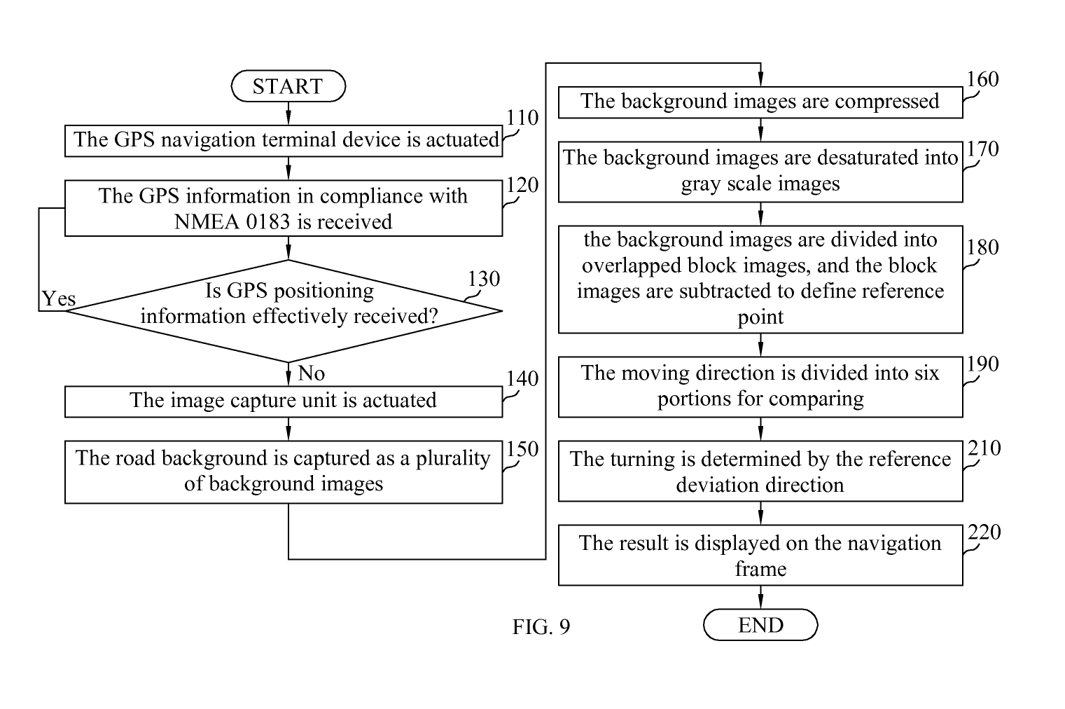

Please refer to FIG. 9, which is a flow chart of the first preferred embodiment, with FIG. 2. To accomplish the means of the present invention, the GPS navigation terminal device 1 must be started for entering into the GPS navigation system 100 (step 110). Following the signal receiving unit 16 receives the GPS positioning signal S1, which is transmitted in compliance with the NMEA 0183 protocol, to obtain the GPS positioning information 122 thereof (step 120). At this time, GPS navigation terminal device 1 determines whether the signal receiving unit 16 can effectively receive GPS positioning information S1 (step 130). If no, the GPS navigation terminal device 1 automatically actuates the image capture unit 13 (step 140), and then, when moving along a curved route, captures the road background as a plurality of road images 17 (step 150).

Following these background images 17 are transmitted to the image computing module 15 of the processing module 11. Moreover, the image processing program 151 of the image computing module 15 compresses the background images to smaller files (step 160) and converts the background images into grayscale to reduce the data volume (step 170). Then the two successive background images are divided into several block images, and the corresponding block images are overlapped and subtracted to define at least one corresponding point (step 180); The turning determining program 152 divides the moving direction into six parts, generates an angle diagram, matches the background images to the angle diagram for comparing (step 190), generates turning determining information (step 210) by comparing the deviation direction of the corresponding point (step 210), and lastly displays the determination result on the navigation frame 141 (step 220).

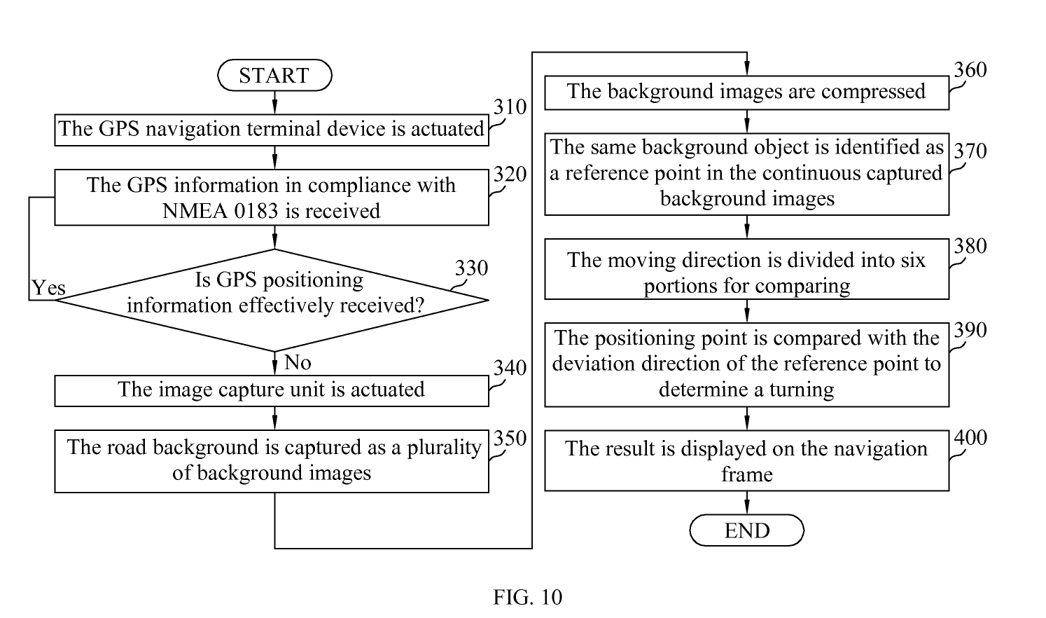

Please refer to FIG. 10, which is a flow chart of the second preferred embodiment, with FIG. 2. In the second preferred embodiment of the present invention, the GPS navigation terminal device 1 must be started for entering into the GPS navigation system 100 (step 310). Following the signal receiving unit 16 receives the GPS positioning signal S1, which is transmitted in compliance with the NMEA 0183 protocol, to obtain the GPS positioning information 122 thereof (step 320). At this time, GPS navigation terminal device 1 determines whether the signal receiving unit 16 can effectively receive GPS positioning information S1 (step 330). If no, the GPS navigation terminal device 1 automatically actuates the image capture unit 13 (step 340).

Then the image capture unit 13 can be utilized to capture the background images 17 (step 350), at this time, the turning determining program 152 will utilize the principle of pattern matching and cross correlation to identify a background object 18 as a positioning point P in the background images 17 (step 360). After defining a positioning point P, a background object 18 can be focused, that is, the same background object 18 is identified as a reference point P′ on the background images 17 following the captured background images 17 (step 370).

Preferably, the turning determining program 152 can divide the image capture effective angle θ into six parts and divide the background images 17 accordingly (step 380). In addition, the turning determining program 152 can generate the turning determining information by comparing the deviation direction of the positioning point P and the reference point P′ with the dividing line (not shown) of the background images 17 (step 390). Finally, the turning determining program 152 can display the determination result on the navigation frame 141 (step 400).

People with general skill in the art would easily understand that, comparing to the conventional GPS navigation system, the terminal device 1 in present invention comprises an image capture unit 13 and an image computing module 15, so the driver's moving turning information can be determined by capturing the road images and the GPS navigation interruption caused by the hindrance 300 can be effectively solved. Even suffering from the bad weather, hindrance above, or GPS navigation malfunction, the driver can still obtain position and moving direction by combining the turning result computed from the present invention with the pre-stored map information. Moreover, comparing to the conventional wheel rotary speed transducer in the DR technique, the present invention avoids the transducer determination fail under the situation of the slipped wheel, the tire radical change caused by the tire pressure or tire worn clown, and the transducer damage. Thus the navigation accuracy can be improved and the driving safety can be assured.

While particular embodiments of the present invention have been shown and described, it will be obvious to those skilled in the art that, based upon the teachings herein, changes and modifications may be made without departing from this invention and its broader aspects. Therefore, the appended claims are intended to encompass within their scope of all such changes and modifications as are within the true spirit and scope of the exemplary embodiments of the present invention.

What is claimed is:

1. A global positioning system (GPS) terminal device, for providing a navigation display when the GPS terminal device is moving along a curved path and when GPS information is not available, the GPS terminal device comprising:
a storage unit, for storing at least one map information;
an image capture unit, for capturing a plurality of background images upon the GPS terminal device moving along the curved path; and
a processing module, electrically connected to the storage unit and the image capture unit, for determining a turning motion according to the map information and the background images so as to generate turning determining information, and the processing module providing the navigation display in accordance with the turning determining information.

2. The GPS terminal device as claimed in claim 1, wherein the processing module comprises an image computing module to determine the turning motion according to the background images so as to generate the turning determining information.

3. The GPS terminal device as claimed in claim 2, wherein the image computing module comprises an image processing program.

4. The GPS terminal device as claimed in claim 2, wherein the image computing module comprises a turning determining program to determining the turning motion.

5. The GPS terminal device as claimed in claim 1, wherein the image capture unit comprises a charge coupled device.

6. The GPS terminal device as claimed in claim 1, wherein the GPS information is transmitted in compliance with the protocol defined by National Marine Electronic Association 0183 (NMEA 0183).

7. The GPS terminal device as claimed in claim 1, further comprising a display unit to present the navigation display according the turning determining information.

8. A navigation method for providing a navigation display while a GPS terminal device is moving along a curved path and when GPS information of the GPS terminal device is not available, the navigation method comprising the following steps of:
(a) storing at least one map information;
(b) capturing a plurality of background images upon the GPS terminal device moving along the curved path;
(c) determining a turning motion according to the map information and the background images so as to generate turning determining information; and
(d) generating the navigation display according to the turning determining information.

9. The navigation method as claimed in claim 8, wherein the step (c) further comprises compressing the background images.

10. The navigation method as claimed in claim 8, wherein the step (c) further comprises converting the background images into grayscale images.

11. The navigation method as claimed in claim 8, wherein the step (c) further comprises segmenting the background images into a plurality of block images.

12. The navigation method as claimed in claim 11, wherein the step (c) further comprises subtracting grayscale values of the block images corresponding to two successive background images of the plurality of background images so as to define at least one corresponding point.

13. The navigation method as claimed in claim 12, wherein the step (c) further comprises generating the turning determining information by identifying a deviation direction of the corresponding point.

14. The navigation method as claimed in claim 8, wherein the step (c) further comprises identifying a background object from each of the two successive background images of the plurality of background images, and taking the background object in each of the two successive background images as a positioning point and a reference point respectively.

15. The navigation method as claimed in claim 14, wherein the step (c) further comprises identifying a deviation direction of the positioning point and the reference point so as to generate the turning determining information.
